(19) United States
(12) Patent Application Publication
(10) Pub. No.: US 2016/0031067 A1
(43) Pub. Date: Feb. 4, 2016

(54) Mechanised Spanner

(71) Applicant: Stud-Mate Limited, Maidstone (GB)

(72) Inventor: Matthew Batt, Maidstone (GB)

(21) Appl. No.: 14/812,253

(22) Filed: Jul. 29, 2015

(30) Foreign Application Priority Data
Jul. 30, 2014 (GB) 1413503.2

(51) Int. Cl. B25B 21/00; B25F 5/00; B25B 13/08

(52) U.S. Cl. CPC B25B 21/007; B25B 13/08; B25F 5/001

(57) ABSTRACT

A mechanised spanner for driving a nut along a threaded rod includes a housing and a drivetrain. The drivetrain has an input shaft and an output member mounted for rotation within the housing. The input shaft rotates the output member during use. An insert is attachable to and rotatable with the output member of the drivetrain and has a jaw for receiving and engaging a nut. The insert is attachable to and rotatable with the output member by a clip, which clips to an insert retainer in the output member and includes an elongate member protruding from the insert which terminates in a detent. The insert retainer has a clip cavity and a moveable retaining wall for bearing against the detent of the clip; retaining the insert in the output member. The insert may be replaced with a different insert for receiving and engaging a nut with different dimensions.

### CROSS REFERENCE TO RELATED APPLICATIONS

This application claims priority to Great Britain patent application no. 1413503.2 filed on Jul. 30, 2014; the entirety of which is incorporated by reference herein.

### BACKGROUND OF THE INVENTION

1. Field of the Invention

The present invention relates to a mechanised spanner which can drive a nut along a threaded rod

2. Background

Some fabrications, such as conduit for services as are typically installed above suspended ceilings, incorporate multiple long threaded rods (bolts) in their construction. It is necessary to manually thread one or more nuts along each bolt, along part or all of its length, when constructing such fabrications. The longer the threaded rods involved, the greater the amount of time that must be allocated to driving nuts along them, potentially increasing the impact on associated project schedules.

In constructing conduit above a ceiling, the worker or workers involved will often need to spend considerable time working at height, using ladders or scaffolding in order to reach the relevant components. As threading a nut along a bolt is a lengthy process, this increases the risk of sustaining an injury associated with working at height by virtue of the length of time it takes to complete the process. The process of threading a nut along a bolt can require a worker to work with their arms raised for protracted periods of time, which can quickly become tiring. It also often involves repetitive hand and wrist movements to incrementally rotate each nut, whether using a spanner or not, which may aggravate or eventually lead to conditions such as Repetitive Strain Injury (RSI) and Carpal Tunnel Syndrome (CTS).

It is an object of the present invention to reduce or substantially obviate the aforementioned problem.

### SUMMARY OF THE INVENTION

According to a first aspect of the present invention, there is provided a mechanised spanner for driving a nut along a threaded rod comprising: a housing and a drivetrain; the drivetrain including an input shaft, and an output member mounted for rotation within the housing, the output member rotating when the input shaft rotates during use; an insert which is attachable to and rotatable with the output member of the drivetrain, the insert having a jaw for receiving and engaging the nut; the insert being attachable to and rotatable with the output member by means of at least one clip, which clips to an insert retainer in the output member; the clip including an elongate member protruding from the insert, terminating in a detent; the insert retainer including a clip cavity and a moveable retaining wall for bearing against the detent of the clip, hence retaining the insert in the output member; and the insert being detachable from the output member for replacement with a different insert for receiving and engaging a nut with different dimensions.

Advantageously, the mechanised spanner enables a worker to rapidly drive a nut along a threaded rod, greatly reducing the time spent per nut when constructing for example conduit for cable runs and other services. The housing houses and protects the internal components of the mechanised spanner, including the drivetrain, as well as mitigating the risk of injury from catching a finger in moving parts of the drivetrain. The drivetrain has an input shaft which can be used to apply torque through the drivetrain to rotate the output member, driving the nut along the threaded rod. Furthermore, the nut can be received and engaged by the jaw of an insert to secure the nut within the output member before it begins rotating. Having multiple attachable/detachable inserts allows a different size of nut to be accommodated by each insert without requiring entirely new mechanised spanners

Using at least one clip ensures that the insert and engaged nut are securely held during use when the output member is rotating. It also prevents the insert from detaching at high speed and potentially breaking objects or injuring one or more bystanders, as the clip connects firmly to the insert retainer.

The insert may be detachable from the insert retainer by means of a release trigger. Preferably, pressing the release trigger may compress a retaining spring by displacing the insert retainer, thereby removing the retaining wall from the detent, allowing the detent to exit the clip cavity so that the insert may be detached from the output member. Most preferably, the insert retainer may have an internal wall angled relative to at least one surface of the clip as engaged in the clip cavity. This enables the internal wall to push the clip out of the clip cavity when the release trigger is pressed. The angle of the internal wall may be substantially between 30 and 60 degrees, and preferably may be at substantially 45 degrees.

The clip cavity can receive the elongate member and detent, securing the detent inside the insert retainer against the retaining wall. The release trigger allows the user to selectively detach the insert with ease, when the output member is at rest and oriented in an open configuration. The insert is retained until the release trigger is pressed, upon which the retaining wall is displaced from the detent, allowing removal of the insert. The retaining spring restores the insert retainer and release trigger to their default positions when the release trigger is no longer pressed. The angled internal wall of the insert retainer pushes the clip out of the clip cavity as the insert retainer is displaced, displacing the clip and detaching the insert. The angled internal wall actively ejects the insert rather than requiring further action to detach it. Having the internal wall angled between 30 and 60 degrees, or at substantially 45 degrees, relative to a clip surface leads to a sizeable component of the release trigger force being directed perpendicularly, causing the clip to be displaced.

The output member may include: a first component, a second component, a primary gear, the insert retainer, and a mechanism for engaging the insert, where the primary gear may be disposed between and radially extends beyond the first and second components. Preferably, the primary gear may be substantially C-shaped.

The primary gear enables the output member to engage with and be driven by the rest of the drivetrain. The primary gear is C-shaped to enable the insert to be easily attached to and detached from the center of the output member. A mechanism for engaging the insert prevents it from deviating from the plane of rotation inside the output member, ensuring that the nut can continue to be threaded in a controlled manner, without the nut escaping the insert and requiring the user to stop and re-engage it in the insert. The first and second components house the insert retainer, release trigger and the mechanism for engaging the insert, and sandwich the primary gear whilst allowing it to engage with the remainder of the drivetrain.

The mechanism for engaging the insert may include one or more projections which may be located on at least one of the following: the first component; the second component; internal sidewalls of the output member.

The first and/or second component projections maintain the position of the insert within the output member during rotation. The projections bear against the periphery of the adjacent upper surfaces of the insert to achieve this. Internal sidewall projections provide a means of aligning and further supporting the position of the insert within the output member.

One or more substantially C-shaped bearings may be disposed in grooves in the housing, in contact with the exterior of the first and/or second components of the output member.

Using one or more bearings decreases the effective friction opposing rotation of the output member, reducing the power needed to rotate the output member and the heat generated during rotation. Using one or more bearings therefore prolongs the lifespan of the device.

The insert may rotate at substantially the same rate as the output member during use.

This prevents inefficient rotation of the insert relative to the output member, which would be disadvantageous as it would generate heat in the output member through friction. It would also be an inefficient use of input energy, and quickly would wear out the components.

The insert may include at least one mechanism for restricting the displacement of the nut relative to the insert during use. Preferably, displacement of the nut within its transverse plane relative to the insert may be restricted by at least one outer retainer, where the outer retainer may include a pair of opposing clips, which may each terminate in a detent. Equally, displacement of the nut perpendicular to its transverse plane relative to the insert may be restricted by at least one upper retainer and at least one lower retainer, where each of the upper and lower retainers cover at least part of the nut.

Controlled rotation of the nut is important to safely drive the nut along a threaded rod, but the nut may become displaced relative to the insert and output member as small variations in the position of the nut after each rotation may lead to a net displacement of the nut. To prevent this, outer, upper and lower retainers hold the nut to restrict its possible motion within the insert, thereby ensuring its rotation is limited to the rotation of the insert. Resilient opposing clips ending in detents are advantageous as they allow the insert to retain the nut without being dosed at its receiving end, but are flexible enough to allow relatively easy removal of the nut after having been driven along a threaded rod. Upper and lower projections in turn retain the nut at all angles during rotation, preventing it from over- or under-rotating and slipping out of the insert.

The insert may be one of a plurality of inserts provided, each of which may have a different jaw to receive and engage a nut of different dimensions.

Providing a plurality of inserts with the device allows a range of different sizes of nut to be driven by the same device, albeit with a particular insert being used at any one time. Different diameters of nut may require different complementary inserts, and different heights of nut may ideally have separate inserts too, but a given nut may of course fit acceptably for use into an insert with a jaw complementing its diameter but not its height.

The drivetrain may include two auxiliary gears which functionally connect to the primary gear of the output member, and may include a secondary gear which functionally connects to each of the two auxiliary gears. At least one of the auxiliary gears may remain functionally connected to the primary gear during rotation of the output member. Preferably, the secondary gear may include a first bevel gear securely mounted on its surface for co-rotation. More preferably, the input shaft of the drivetrain may end in a second bevel gear which functionally connects to the first bevel gear. Each auxiliary gear may be a spur gear.

As the open configuration implies, one section of the output member is open, so having two separate auxiliary gears drive the primary gear ensures that the open section can pass by each auxiliary gear without an overall loss of drive, as the other auxiliary gear remains functionally connected to the primary gear, driving rotation of the output member. Each component is needed so that drive from the rotating input shaft can be transferred through from the input shaft to the first bevel gear through the second bevel gear, rotating the secondary gear and auxiliary gears, which in turn drive rotation of the primary gear and output member. Spur gears provide a robust means of transferring the drive.

The input shaft may extend substantially outside the housing which may enable an external device to connect to and drive it. Preferably, the input shaft may include a universal joint.

The device may be provided without its own power source, which makes the device lightweight. This means that it can easily be raised above head-height during use to continue driving a nut along a long threaded rod. As such, the input shaft must be driven by another device. Extending the input shaft outside the housing allows an external device to connect to and drive the input shaft, allowing the device to operate. By including a universal joint in the input shaft, the angle at which the external device connects to the input shaft can be manipulated depending on the available space for installation.

The housing may have at least one port for removably securing a handle.

Using a handle which can be secured to the housing allows the user to stabilize the device as they drive a nut along a threaded rod, providing fine control over the orientation of the device. This reduces the likelihood of grinding the nut against the thread of the rod, which would potentially damage the nut and/or threaded rod as well as put undue strain through the drivetrain of the device. It also decreases the minimum weight of the device, making it easier to maneuver and reducing the weight placed on any external driving device.

According to a second aspect of the present invention, there is provided a mechanised spanner for driving a nut along a threaded rod comprising: a housing and a drivetrain; the drivetrain including an input shaft, and an output member mounted for rotation within the housing, the output member rotating when the input shaft rotates during use; an insert which is attachable to and rotatable with the output member of the drivetrain, the insert having a jaw for receiving and engaging the nut; the insert being attachable to and rotatable with the output member by means of at least one clip, which clips to an insert retainer in the output member; the insert being detachable from the insert retainer by means of a release trigger; and the insert being detachable from the output member for replacement with a different insert for receiving and engaging a nut with different dimensions.

The mechanised spanner according to the second aspect of the invention may include any feature or combination of features according to the first aspect of the invention.

### BRIEF DESCRIPTION OF SEVERAL VIEWS OF THE DRAWINGS

For a better understanding of the present invention, and to show more clearly how it may be carried into effect, reference will now be made by way of example only to the accompanying drawings, in which:

FIG. 1 shows an exploded perspective view of a first embodiment of a mechanised spanner according to the invention;

FIG. 2 shows a perspective view of part of the mechanised spanner of FIG. 1, showing in particular the drivetrain;

FIG. 3 shows a perspective view of the output member and insert of the mechanised spanner of FIG. 1;

FIG. 4 shows a cross-section through the output member and insert of the mechanised spanner of FIG. 1;

FIG. 5 shows a perspective view of the insert of the mechanised spanner in FIG. 1;

FIG. 6 shows a close perspective view of the C-shaped bearing of the mechanised spanner in FIG. 1;

FIG. 7 shows a lateral view of the C-shaped bearing with the output member in its operative position;

FIG. 8 shows a perspective view of the assembled mechanised spanner of FIG. 1; and

FIG. 9 shows a perspective view of an alternative drivetrain for use in a mechanised spanner according to the invention.

### DETAILED DESCRIPTION OF PREFERRED EMBODIMENTS

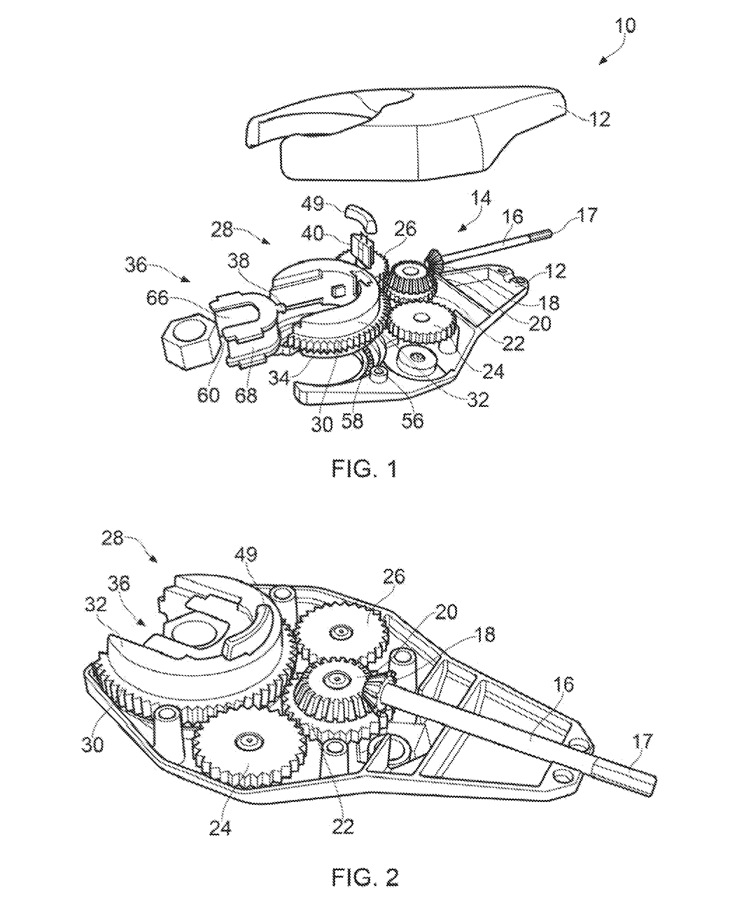

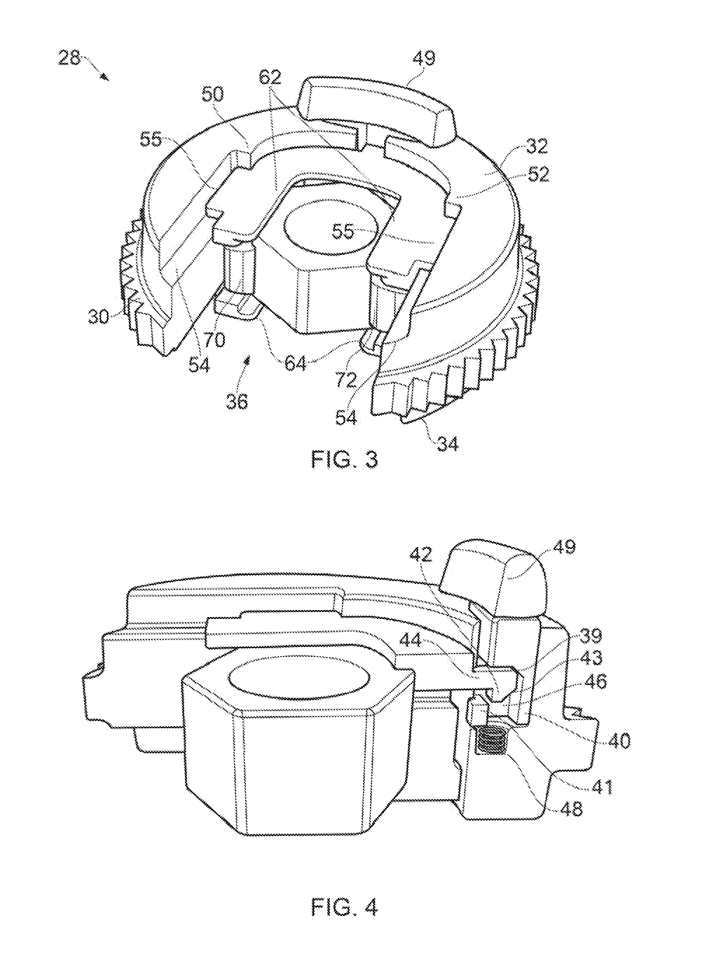

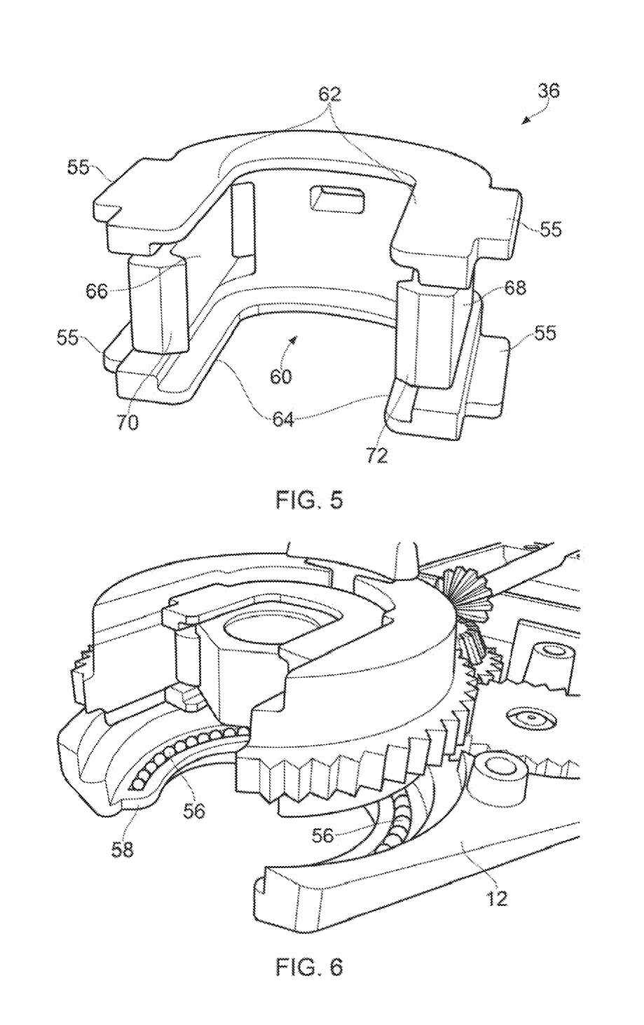

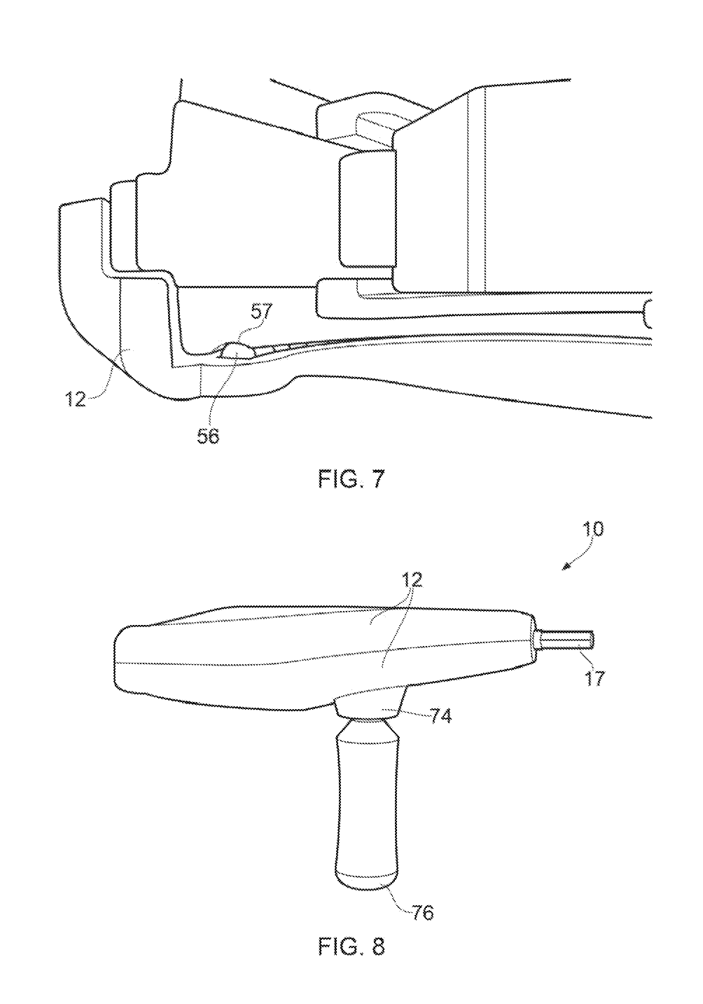

Referring firstly to FIGS. 1 to 7, a first embodiment of a mechanised spanner is indicated generally at 10. The housing 12 contains the drivetrain indicated generally at 14, with the input shaft 16 extending sufficiently rearward of the device to enable an external device such as a drill to connect to it. The input shaft 16 has a hexagonal cross-section 17 at its end for the same reason.

The internal end of input shaft 16 terminates in a second bevel gear 18 inside the housing 12, which mechanically interlocks with a first bevel gear 20. The first bevel gear 20 is mounted on the surface of a secondary gear 22, which itself mechanically interlocks with first and second auxiliary gears 24 and 26. The first and second auxiliary gears 24, 26 are located on the far side of the secondary gear 22 to the input shaft 16. They are placed symmetrically at an angle of around 60 degrees on either side of the central axis of the input shaft 16, and in a common horizontal plane with the secondary gear 22. Both gears 24, 26 also mechanically interlock with an output member indicated generally at 28 through a primary gear 30.

In the output member 28, the primary gear 30 is C-shaped and located between a first component 32 and a second component 34. An insert indicated generally at 36 with a clip 38 can be mounted inside the output member 28, by securing the clip 38 against an insert retainer 40, located opposite the open end of the output member 28. The clip 38 includes an elongate member 44 extending rearward from the open end of the insert 36, ending in a detent 42. The detent 42 of the clip 38 hooks into a clip cavity 46 and against a retaining wall 41, with a retaining spring 48 holding the insert retainer 40 and clip cavity 46 in position. A release trigger 49 is provided above the clip cavity 46 and insert retainer 40 for detaching the insert 36 from its secured position. This is facilitated by the clip cavity 46 having an upper internal surface (or internal wall) 39 angled at around 45 degrees. Similarly, insertion of the clip 38 is facilitated by the detent 42 having an external surface 43 angled at around 45 degrees. The arrangement of the clip 38 and the insert retainer 40 is best seen in FIG. 4.

The output member 28 also has projections 50, 52 from its first and second components 32, 34 which restrict vertical displacement of the insert 36 during rotation. Similarly, projections 54 from the sidewalls of the output member 28 allow the insert 36 to be guided via corresponding projections 55 into the output member 28 when securing the clip 38 within the insert retainer 40, whilst also restricting its relative displacement. Additionally, the output member 28 is mounted on a substantially C-shaped bearing 56 which is located in a housing groove 58 in the housing 12. This bearing 56 is composed of a plurality of individual hard metal spheres which contact the exterior of the second component 34 of the output member 28 in order to reduce the effective friction it experiences when rotating during use. The C-shaped bearing 56 complements a further groove 57 in the exterior of the second component 34, increasing the contact area between each individual part of the bearing 56 and the output member 28. This means that the output member 28 is fully supported by the bearing 56 in the orientation shown, ensuring that there is minimal friction between the surfaces of the housing 12 and the output member 28 during use.

In this embodiment, the components of the output member 28 (i.e. the primary gear 30, the first component 32, the second component 34) are not separate pieces but are formed as a single piece. This simplifies the fabrication of this component, and also makes it more durable as far as the forces experienced during use are concerned. The single piece output member may be moulded. It may be made from a polymer known commercially as ABS (acrylonitrile butadiene styrene).

Insert 36 has a jaw 60 to receive and engage a nut of given dimensions, although the output member 28 is capable of receiving any one of a plurality of inserts with different jaw dimensions, for receiving and engaging nuts with different dimensions. The insert 36 has upper and lower retainers 62, 64 which overlap a nut to restrict its vertical displacement relative to the insert 36. The insert 36 also has opposing clips (or outer retainers) 66, 68 to restrict the horizontal displacement of a nut relative to the insert 36, with each clip 66, 68 ending in a detent 70, 72 respectively. The clips 66, 68 are resilient enough that they do not release the nut whilst the device is in use, but flexible enough that the nut can be disengaged by deliberately pulling the device away from the nut when it has been threaded along a rod.

FIG. 8 depicts a port 74 on the underside of the device with a female threaded section for accepting and securing a corresponding male threaded section of a handle 76. In another embodiment, a further port is available on a lateral side of the device, in addition to or instead of port 74 on the lower face of the device.

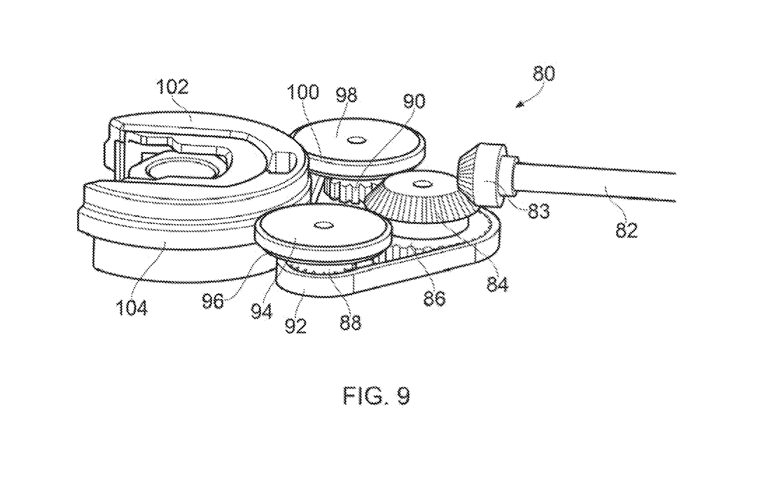

FIG. 9 shows an alternative drivetrain indicated generally at 80. This has an input shaft 82 terminating in a second bevel gear 83 at one end, which mechanically interlocks with a first bevel gear 84. The first bevel gear 84 is mounted on the surface of a secondary gear 86, with first and second auxiliary gears 88 and 90 located in a common horizontal plane as the secondary gear 86, and on the far side of the secondary gear 86 to the input shaft 82. The first and second auxiliary gears 88, 90 are placed symmetrically at an angle of around 60 degrees about the central axis of the input shaft 82. Gears 86, 88 and 90 are located in close proximity but do not directly interlock, instead being connected through a toothed belt 92 which runs around them. The teeth of the toothed belt 92 mechanically interlock with the toothed surfaces of gears 86, 88 and 90, with minimal slack in the toothed belt 92.

The first auxiliary gear 88 supports a fixed horizontal wheel 94 with a rubberized circumference 96, oriented to have a common central rotational axis with the gear 88. Similarly, the second auxiliary gear 90 supports a fixed horizontal wheel 98 with a rubberized circumference 100, oriented to have a common central rotational axis with the gear 90. The wheels 94, 98 are located in the same horizontal plane, and each contact an output member 102 along a rubberized portion 104 which partially extends around the perimeter of the output member 102.

In this case, rotating the input shaft 82 and the second bevel gear 83 turns the first bevel gear 84 and secondary gear 86. The toothed belt 92 then rotates with gear 86, concurrently rotating the first and second auxiliary gears 88, 90 due the mechanical interlink, causing mutual rotation as the belt 92 travels. The wheels 94 and 98 rotate in the same direction as the gears 88 and 90 as they are fixed to them.

Friction between the rubberized portion 104 of output member 102 and the rubberized circumference 96 of wheel 94 causes the output member 102 to turn. Furthermore, friction between the rubberized portion 104 of output member 102 and the rubberized circumference 100 of wheel 98 also causes the output member 102 to turn. Two wheels are required so that the output member 102 is always being driven by at least one wheel, as the open portion of the output member 102 passes by each wheel in turn. This embodiment of the drivetrain does not require the four gears to directly mesh, and so requires less precision during fabrication. Should a nut become cross-threaded, this drivetrain also has the advantage of not transmitting as large a shock to the input shaft (as would occur in the first embodiment), because the rubberized surfaces 96, 100 of wheels 94, 98 are able to continue turning, subject to increased friction.

To use the device, a nut is horizontally loaded into the insert 36 at its open end, being secured in its jaw 60 by the resilient opposing clips 66, 68 and outer retainers 62, 64. Alternatively, the nut may be initially manually driven a short way onto and along a threaded rod before attaching the insert to the nut.

The insert 36 and output member 28 are then oriented in the same plane (tilting the device 10 to modulate the orientation of the output member 28), with the open end of the insert 36 facing away from the output member 28. The insert 36 is then secured within output member 28, guiding it along the sidewall projections 54 and between the first and second component projections 50, 52. The angled external surface 43 of detent 42 facilitates the displacement of the retaining wall 41 (along with clip cavity 46 and the rest of the insert retainer 40) as clip 38 enters the insert retainer 40, as a component of the force is directed to moving the retaining wall 41 towards the retaining spring 48, compressing it, by virtue of the angle of the external surface 43. The clip 38 is then secured inside the insert retainer 40 by the retaining wall 41 once the detent 42 passes beyond its lip, with the insert retainer 40 held in place against the clip 38 by the retaining spring 48 until the release trigger 49 is pressed.

After securing the insert 36 inside the output member 28, an external driving device with a power source (such as a drill) is securely connected to the exposed end of the input shaft 16. If not already located on a threaded rod, the nut is correctly aligned for achieving this by adjusting the orientation of the device relative to a threaded rod. Activating the drill rotates the input shaft 16, also rotating the second bevel gear 18 at the internal end of the input shaft 16. This in turn rotates the first bevel gear 20 and first auxiliary gear 22, which turn the second and third auxiliary gears 24 and 26. These gears then cause the output member 28 (and insert 36 with the nut) to begin rotating as they mesh with primary gear 30. As primary gear 30 has a non-continuous toothed surface (which is roughly C-shaped), both gears 24 and 26 are required to ensure that drive is supplied to primary gear 30 by at least one gear during a single rotation.

As the output member 28, insert 36 and nut rotate, the nut will be driven along the threaded rod, and the device will need to be manually moved along relative to the rod at a corresponding rate, to avoid grinding the nut on the rod or damaging the device. The substantially C-shaped bearing 56 in the groove 58 adjacent to the second component 34 (which has a further groove 57 fitting to the C-shaped bearing 56) ensures that frictional energy losses are minimised during rotation of the output member 28 by fully supporting it. Each individual hard metal sphere rotates on its own axis as the output member 28 rotates adjacent to them, reducing friction at high rotational speeds as compared to operating without the bearing 56.

Once the nut has reached the desired location on the rod, the external driving device is deactivated to cease driving rotation of the output member 28. If the output member 28 is not oriented in an open configuration, the external driving device can be carefully reactivated to slowly drive rotation of the output member 28 until it is oriented in an open configuration. The device can then be disengaged from the nut by pulling it away from the nut and threaded rod, as the opposing clips 66, 68 of the insert 36 are flexible enough to release the nut.

If the insert needs to be changed to engage a different size of nut, the current insert can be removed by pressing the release trigger 49. Pressing the release trigger 49 compresses the retaining spring 48, concurrently displacing the insert retainer 40 (with the clip cavity 46 and the retaining wall 41) away from the release trigger 49. In so doing, the retaining wall 41 is moved clear of the detent 42 (as shown in FIG. 4) as the upper internal surface 39 of the clip cavity 46 approaches the end of the clip 38. On contact, the upper internal surface 39 exerts force with a horizontal component on the detent 42 to displace the insert 36 away from clip cavity 46. As the retaining wall 41 has been displaced from the path of the insert 36, the insert 36 is therefore displaced outwards and detached from the output member 28 as the release trigger 49 is depressed. Once the release trigger 49 is released, the retaining spring 48 expands and returns the insert retainer 40 and release trigger 49 to their default positions.

The above description represents two embodiments of the mechanised spanner, but other embodiments are also envisaged within the scope of the claims. One embodiment could incorporate a power source to drive the input shaft, obviating the need to use a drill or other external driving device. This could potentially be incorporated into a handle on the device, containing a motor, battery and charging port. A further embodiment might use an insert which attaches and detaches vertically from the output member, enabling a circular primary gear to be used and simplifying the rest of the drivetrain to require only one auxiliary gear. Different combinations of drivetrain components are also envisaged for use in different embodiments of a mechanised spanner, using gears, belts or other components.

The embodiments described above are provided by way of example only, and various changes and modifications will be apparent to persons skilled in the art without departing from the scope of the present invention as defined by the appended claims.

What is claimed is:

1. A mechanised spanner for driving a nut along a threaded rod comprising:
a housing and a drivetrain;
the drivetrain including an input shaft, and an output member mounted for rotation
within the housing, the output member rotating when the input shaft rotates during use;
an insert which is attachable to and rotatable with the output member of the drivetrain, the insert having a jaw for receiving and engaging the nut;
the insert being attachable to and rotatable with the output member by means of at least one clip, which clips to an insert retainer in the output member;
the clip including an elongate member protruding from the insert, terminating in a detent;
the insert retainer including a clip cavity and a moveable retaining wall for bearing against the detent of the clip, hence retaining the insert in the output member;
wherein the insert is detachable from the output member for replacement with a different insert for receiving and engaging a different nut that is different in a dimension from the nut.

2. The mechanised spanner as claimed in claim 1, in which the insert is detachable from the insert retainer by means of a release trigger.

3. The mechanised spanner as claimed in claim 2, in which pressing the release trigger compresses a retaining spring by displacing the insert retainer, thereby removing the retaining wall from the detent, allowing the detent to exit the clip cavity so that the insert is detachable from the output member.

4. The mechanised spanner as claimed in claim 3, in which the insert retainer has at least one internal wall angled relative to a surface of the clip as engaged in the clip cavity, enabling the internal wall to push the clip out of the clip cavity when the release trigger is pressed.

5. The mechanised spanner as claimed in claim 4, in which a relative angle of at least one internal wall to a surface of the clip is substantially between 30 and 60 degrees.

6. The mechanised spanner as claimed in claim 4, in which a relative angle of at least one internal wall to a surface of the clip is at substantially 45 degrees.

7. The mechanised spanner as claimed in claim 1, in which the output member includes:
a first component,
a second component,
a primary gear,
the insert retainer, and
a mechanism for engaging the insert,
where the primary gear is disposed between and radially extends beyond the first and second components.

8. The mechanised spanner as claimed in claim 7, in which the primary gear is substantially C-shaped.

9. The mechanised spanner as claimed in claim 7, in which the mechanism for engaging the insert includes one or more projections located on at least one of the following: the first component; the second component; internal sidewalls of the output member.

10. The mechanised spanner as claimed in claim 7, in which one or more substantially C-shaped bearings are disposed in grooves in the housing, in contact with an exterior of the first and/or second components of the output member.

11. The mechanised spanner as claimed in claim 1, in which displacement of the nut within its transverse plane relative to the insert is restricted by at least one outer retainer.

12. The mechanised spanner as claimed in claim 11, in which the outer retainer includes a pair of resilient opposing clips, each terminating in a detent.

13. The mechanised spanner as claimed in claim 1, in which displacement of the nut perpendicular to its transverse plane relative to the insert is restricted by at least one upper retainer and at least one lower retainer which each cover at least part of the nut.

14. The mechanised spanner as claimed in claim 1, in which the insert is one of a plurality of inserts provided, each of which has a different jaw to receive and engage a nut of different dimensions.

15. The mechanised spanner as claimed in claim 7, in which the drivetrain includes two auxiliary gears which functionally connect to the primary gear of the output member, and a secondary gear which functionally connects to each of the two auxiliary gears, at least one of the auxiliary gears remaining functionally connected to the primary gear during rotation of the output member.

16. The mechanised spanner as claimed in claim 15, in which the secondary gear includes a first bevel gear securely mounted on its surface for co-rotation.

17. The mechanised spanner as claimed in claim 16, in which the input shaft ends in a second bevel gear which functionally connects to the first bevel gear.

18. The mechanised spanner as claimed in claim 1, in which the input shaft extends substantially outside the housing to enable an external device to connect to and drive it.

19. The mechanised spanner as claimed in claim 1, in which the housing has at least one port for removably securing a handle.

20. A mechanised spanner for driving a nut along a threaded rod comprising:
a housing and a drivetrain;
the drivetrain including an input shaft, and an output member mounted for rotation within the housing, the output member rotating when the input shaft rotates during use;
an insert which is attachable to and rotatable with the output member of the drivetrain, the insert having a jaw for receiving and engaging the nut;
the insert being attachable to and rotatable with the output member by means of at least one clip, which clips to an insert retainer in the output member;
the insert being detachable from the insert retainer by means of a release trigger;
the insert being detachable from the output member for replacement with a different insert for receiving and engaging a nut with different dimensions.
